(19) United States
(12) Patent Application Publication
(10) Pub. No.: US 2010/0328243 A1
(43) Pub. Date: Dec. 30, 2010

(54) MEMS SCANNING TOUCH PANEL AND COORDINATE DECTION METHOD THEREOF

(75) Inventors: Chao-Hsin Wang, Taipei City (TW); Yung-Shan Lin, Taipei City (TW); San-Woei Shyu, Taipei City (TW)

Correspondence Address: WPAT, PC;INTELLECTUAL PROPERTY ATTORNEYS, 2030 MAIN STREET, SUITE 1300, IRVINE, CA, 92614, US

(73) Assignee: E-PIN OPTICAL INDUSTRY CO., LTD, Taipei (TW)

(21) Appl. No.: 12/823,630

(22) Filed: Jun. 25, 2010

(30) Foreign Application Priority Data
Jun. 30, 2009 (TW) 098122191

(51) Int. Cl. G06F 3/041

(52) U.S. Cl. 345/173

(57) ABSTRACT

The present invention discloses a MEMS scanning coordinate detection method and a touch panel thereof, wherein the touch panel comprises a light source module, a MEMS reflector, an image sensor, an image signal processor, and a coordinate calculator. When the laser light from the light source module is reflected by the MEMS reflector, the laser light is transformed into a scanning light beam. When the touch panel is touched by a pen or a finger, the scanning light beam is blocked and two inactive pixels are formed on the image sensor. The electronic signal is transmitted from the image signal processor and calculated by the coordinate calculator to determine the touch point position.

### BACKGROUND OF THE INVENTION

1. Field of the Invention

The present invention relates to a micro-electro-mechanical system (MEMS) scanning coordinate detection method and a touch panel thereof, in particular to an apparatus and a system applied in a related device such as a touch panel and an electronic whiteboard and using a MEMS reflector for scanning and detecting coordinates and a projection area of a touch point.

2. Description of the Related Art

In recent years, computers and related electronic devices such as personal computers, industrial computers, mobile phones and large electronic whiteboards become increasingly popular, touch panels are applied thereto extensively. A finger or a touch pen used for moving a drawing, writing characters, or giving an instruction directly from a display screen to the computer, has become a quick and convenient way of inputting instructions. To allow a computer system to recognize the instruction given by a direct touch on the display screen, it is very important to detect the position (or coordinates) of a touch point correctly and precisely.

Related coordinate detection methods for detecting a touch point on a touch panel using optical approaches are generally adopted. For example, as disclosed in U.S. Pat. No. 4,811,004, two movable beam deflectors are provided for scanning laser beams across the display screen. Each of the two laser beams to be deflected in a scanning pattern which sweeps angularly in a predetermined time interval across the screen. The laser beams are interrupted by a touch point in response to the object. Thus, a reflecting angle will be measured for calculating the position of a touch point. In addition, the position of a touch point may be detected by a method as disclosed in R.O.C. Pat. No. M358363 and by using a charged-coupled device (CCD) image sensor or a complementary metal oxide semiconductor (CMOS) image sensor to capture two images of the touch point, and the two images are used for calculating the position of a touch point. However, it is not easy to determine the depth of field of an image, thus making it more difficult to enhance the resolution for identifying the coordinates. In addition, a touch panel 901 as disclosed in U.S. Pat. No. 6,664,952, and Japan Pat. Publication Nos. 2008-217273, JP2008-036297, JP2001-264011 and as shown in FIG. 1 comprises two optical units 902, a retro-reflection plate 903 on three edges of a display screen, where each optical unit 902a (902b) includes a laser light source, a collimator lens, a polygon mirror, a light receiving lens, and a photo-electric detector. After the laser light source emits a light, the light is focused into a laser light beam with a smaller cross-section by the collimator lens, and projected onto the polygon mirror. With a high-speed rotational speed of the polygon mirror, the laser light is scanned onto the display screen, and following the laser light is reflected by the retro-reflection plate. After being focused by the light receiving lens, the laser light is detected by the photo-electric detector. That is, the optical path is laid out from the laser light source through the polygon mirror, the display screen surface, the retro-reflection plate, the display screen surface, the light receiving lens, and finally to photo-electric detector. When a touch point P1 is produced, the scanning light beam is blocked, and two angles of the blocked light on both edges can be used for a trigonometric calculation of coordinates of the touch point P1. However, this method involves a very long optical path, and is limited by the angle of the retro-reflection plate and the focusing capability of the light receiving lens. Thus it is difficult to enhance the resolution for identifying the coordinates. Particularly, when this method is applied to a large display screen, the optical path is too long to maintain light intensity, thus affecting the resolution for determining the coordinates.

With reference to FIG. 2, the coordinate detection method of a touch point of a touch panel using an optical method is disclosed in R.O.C. Pat. No. 1304544 and Japan Pat. Publication No. 06-309100. The touch panel 901 comprises two laser light sources 905, two light reflectors 906, and two light receiver modules 907 disposed opposite to the light reflector 906, wherein the light receiver module 907 includes a plurality of rows and columns of light receiving elements 9071. After the laser light source 905 emits a laser light, light reflector 906 distributes the laser light into grid lights with rows and columns horizontally and vertically, and the light receiver module 907 receives the laser light having an optical path which is originated from the laser light source, then reflected to form grid lights, transmitted to the display screen surface, and finally received by light receiver module. The grid light is blocked once a touch point P1 was produced, and then the light receiver modules on both edges will receive inactive light receiving elements 9071, thus the coordinates of the touch point can be obtained directly. Although this method is simple and easy and involves a short optical path, yet the resolution is limited by the density of grid lights that can be produced by the light reflector 906, such that it is difficult to enhance the resolution for identifying the coordinates. If this method is applied to a large display screen, the laser light is separated and distributed into a plurality of grid lights. Thus the light intensity is relatively too weak to maintain the sensing effect of the light receiving elements 9071.

If the touch panel is used for drawings, it is necessary to further identify a touch area in addition to the coordinate of the touch point, and the detection of the touch area can make the drawing more accurate, and such touch panel can be applied to a large electronic whiteboard. As a result, a method enhancing the resolution of the touch panel, reducing the number of components and cost, and detecting both coordinates of the touch point and area of the touch area accurately can be applied to touch panels with various sizes and higher resolution.

### SUMMARY OF THE INVENTION

A primary objective of the present invention is providing a MEMS scanning touch panel comprising a display screen, a light source module, two MEMS reflectors, an image sensor, a shade, an image signal processor, and a coordinate calculator. The display screen comprises a first edge, a second edge, a third edge, and a fourth edge. The light source module is disposed separately on the first edge of the display screen, and includes two laser light sources and two collimator lens. The laser light source is provided for emitting a laser light, and the collimator lens collects the laser light to form a concentrated parallel laser light which is projected to the center of reflection of the MEMS reflector. The MEMS reflectors are disposed separately on two ends of the first edge of the display screen and are resonantly oscillated along the resonant shaft to scan the laser lights incident to centers of the reflecting surfaces across the display screen so as to form scanning light beams. The image sensor is disposed on the second, third, and fourth edge of the display screen for receiving a scanning light beam and forming a linear image of the scanning light beams. The image signal processor captures a linear image formed by the image sensor, and converts active pixels and inactive pixels in the linear image into sequency electronic signals. The shade is disposed at a position corresponding to the MEMS reflector for blocking a scanning light beam of an invalid area from entering into the display screen. Thus, a ghost image, formed by the scanning light beam of the invalid area, would not be received by the image sensor. The coordinate calculator receives the electronic signal generated by the image signal processor, calculates and outputs coordinate of the touch point according to the coordinates of the center of the reflecting surfaces and the coordinates of inactive pixels.

Another objective of the present invention is to provide a MEMS scanning touch panel comprising a display screen, a light source module, two MEMS reflectors, an image sensor, a shade, an image signal processor, and a coordinate calculator. The light source module is disposed on the first edge of the display screen, and included a laser light source, a collimator lens, and a beam splitter. The laser, light source is provided for emitting a laser light, the collimator lens collect the laser light to form a concentrated parallel laser light beam, and the beam splitter is provided for splitting the laser light into two light beams which are projected to the center of reflecting surface of the MEMS reflector, and then the two light beams scanned by the MEMS reflectors to form scanning light beams.

Also, the image sensor is disposed on the second, third and fourth edge of the display screen for receiving a scanning light beam and forming a linear image of the scanning light beam. The image signal processor captures a linear image formed by the image sensor, and converts active pixels and inactive pixels in the linear image into sequency electronic signals. The shade is disposed at a position corresponding to the MEMS reflector for blocking a scanning light beam of an invalid area from entering into the display screen. Thus, a ghost image, formed by the scanning light beam of the invalid area, would not be received by the image sensor. The coordinate calculator receives the electronic signal generated by the image signal processor, calculates and outputs coordinate of the touch point according to the coordinates of the center of the reflecting surfaces and the coordinates of inactive pixels.

To detect the coordinates of the touch point, the present invention provides a coordinate detection method applied to a MEMS scanning touch panel. The method is comprising the following steps of: triggering MEMS reflectors to oscillate at a predetermined resonant frequency and amplitude; actuating light source modules to emit laser lights, capturing a linear image at each sample time Ts, determining whether or not the electronic signal indicating any inactive pixel, calculating coordinates of inactive pixels, calculating the coordinate of touch point according to the coordinates of the center of reflecting surfaces of MEMS reflectors and the coordinates of inactive pixels, and outputting the coordinate of touch point. That is, the coordinate detecting method comprises the following specific steps of:

S0: starting up MEMS reflectors to allow the MEMS reflectors to oscillate at a predetermined resonant frequency and amplitude, and actuating a light source module to allow the light source module to emit a laser light;

S1: capturing a linear image at each sample time Ts by the image sensor, wherein, once a touch point is appeal on the display screen, the linear image shows active pixels that are not blocked by the touch point and inactive pixels that are blocked by the touch point;

S2: obtaining the coordinates of the touch point by processing the coordinates of inactive pixels and the coordinates of the center of MEMS reflectors, included the steps of:
S21: capturing the linear image by the image sensor, transforming the linear image into an electronic signal by the image signal processor, and transmitting the electronic signal to the coordinate calculator;
S22: whether or not there is an inactive pixel in the electronic signal of the image signal processor is determined by the coordinate calculator; (1) outputting a null signal if there is no inactive pixel; (2) outputting an error signal if there is only one inactive pixel; (3) calculating coordinate positions (X₁,Y₁) and (X₂,Y₂) of the two inactive pixels if there are two discontinuous inactive pixels; calculating coordinates (Xp,Yp) of the touch point, and outputting the signal of the coordinates of the touch point (Xp,Yp);

S3: returning to the step S1 to wait the next sampling time.

Another objective of the present invention is to provide a method of using a MEMS scanning touch panel for detecting vertex coordinates of a quadrilateral which projected by a touch area on the display screen and for detecting coordinate of a geometric center of the quadrilateral. The method comprises the following steps:

S0: starting up MEMS reflectors to allow the MEMS reflectors to oscillate at a predetermined resonant frequency and amplitude, and actuating a light source module to allow the light source module to emit a laser light;

S1: capturing a linear image at each sample time Ts by the image sensor, wherein the linear image shows active pixels that are not blocked by the touch area and inactive pixels that are blocked by the touch area, once a touch area is appeal on the display screen;

S2: obtaining the vertex coordinates of the touch area and the coordinate of geometric center of the quadrilateral by processing the coordinates of inactive pixels and the coordinates of the center of MEMS reflectors, which including the steps of:
S21: capturing the linear image by the image sensor, transforming the linear image into an electronic signal by the image signal processor, and transmitting the electronic signal to the coordinate calculator;
S22: whether or not there is an inactive pixel in the electronic signal of the image signal processor is determined by the coordinate calculator; (1) outputting a null signal if there is no inactive pixel; (2) outputting an error signal if there is only one inactive pixel; (3) calculating coordinate positions (X₁₁,Y₁₁) and (X₁ₘ,Y₁ₘ) of end points of a first continuous inactive pixel area and coordinate positions (X₂₁,Y₂₁) and (X₂ₙ,Y₂ₙ) of end points of a second continuous inactive pixel area; calculating coordinates (X_{P1},Y_{P1}), (X_{P2},Y_{P2}), (X_{P3},Y_{P3}) and (X_{P4},Y_{P4}) of vertices of a quadrilateral of the touch area according to the coordinate positions (X₁₁,Y₁₁), (X₁ₘ,Y₁ₘ), (X₂₁,Y₂₁) and (X₂ₙ,Y₂ₙ); moreover, obtaining the geometric center coordinates (X_{Pc},Y_{Pc}) of the quadrilateral by the further steps of: calculating the geometric center coordinates (X_{Pc},Y_{Pc}) of the quadrilateral by calculating the coordinates (X_{P1},Y_{P1}), (X_{P2},Y_{P2}), (X_{P3},Y_{P3}) and (X_{P4},Y_{P4}) of vertices of a quadrilateral; and outputting the signal of the coordinates of the geometric center coordinates (X_{Pc},Y_{Pc}), the coordinates of vertices (X_{P1},Y_{P1}), (X_{P2},Y_{P2}), (X_{P3},Y_{P3}) and (X_{P4},Y_{P4});

S3: returning to the step S1 to wait the next sampling time.

Another objective of the present invention is to provide a method of using a MEMS scanning touch panel for detecting vertex coordinates of a quadrilateral which projected by a touch area on the display screen and for detecting coordinate of a homogenous center of the quadrilateral. The method comprises the following steps:

S0: starting up MEMS reflectors to allow the MEMS reflectors to oscillate at a predetermined resonant frequency and amplitude, and actuating a light source module to allow the light source module to emit a laser light;

S1: capturing a linear image at each sample time Ts by the image sensor, wherein the linear image shows active pixels that are not blocked by the touch area and inactive pixels that are blocked by the touch area, once a touch area is appeal on the display screen;

S2: obtaining the vertex coordinates of the touch area and the coordinate of homogenous center of the quadrilateral by processing the coordinates of inactive pixels and the coordinates of the center of MEMS reflectors, included the steps of:
S21: capturing the linear image by the image sensor, transforming the linear image into an electronic signal by the image signal processor, and transmitting the electronic signal to the coordinate calculator;
S22: whether or not there is an inactive pixel in the electronic signal of the image signal processor is determined by the coordinate calculator; (1) outputting a null signal if there is no inactive pixel; (2) outputting an error signal if there is only one inactive pixel; (3) calculating coordinate positions (X₁₁,Y₁₁) and (X₁ₘ,Y₁ₘ) of end points of a first continuous inactive pixel area and coordinate positions (X₂₁,Y₂₁) and (X₂ₙ,Y₂ₙ) of end points of a second continuous inactive pixel area; calculating coordinates (X_{P1},Y_{P1}), (X_{P2},Y_{P2}), (X_{P3},Y_{P3}) and (X_{P4},Y_{P4}) of vertices of a quadrilateral of the touch area according to the coordinate positions (X₁₁, Y₁₁), (X₁ₘ,Y₁ₘ), (X₂₁,Y₂₁) and (X₂ₙ,Y₂ₙ); moreover, obtaining the area A_{P} of the quadrilateral and the homogenous center coordinates (X_{Pd},Y_{Pd}) of the quadrilateral by the further steps of: calculating the area A_{P} of the quadrilateral according to the coordinates (X_{P1},Y_{P1}), (X_{P2},Y_{P2}), (X_{P3},Y_{P3}) and (X_{P4},Y_{P4}); calculating the homogenous center coordinates (X_{Pd},Y_{Pd}) of the quadrilateral by calculating the coordinates (X_{P1},Y_{P1}), (X_{P2},Y_{P2}), (X_{P3},Y_{P3}) and (X_{P4},Y_{P4}) of vertices of a quadrilateral; and outputting the signal of the coordinates of the homogenous center coordinates (X_{Pd},Y_{Pd}), the coordinates of vertices (X_{P1},Y_{P1}), (X_{P2},Y_{P2}), (X_{P3},Y_{P3}) and (X_{P4},Y_{P4}) and the area A_{P} of the quadrilateral;

S3: returning to the step S1 to wait the next sampling time.

### BRIEF DESCRIPTION OF THE DRAWINGS

FIG. 1 is a schematic view of a conventional touch panel;

FIG. 2 is a schematic view of another conventional touch panel;

FIG. 3 is a schematic view of a MEMS scanning touch panel in accordance with a first preferred embodiment of the present invention;

FIG. 4 is a schematic view showing a scanning range of a MEMS scanning touch panel of the present invention;

FIG. 5 is a schematic view showing a scanning angle of a MEMS reflector;

FIG. 6 is a schematic view showing a resonant angle and a scanning angle of a MEMS reflector;

FIG. 7 is a schematic view showing a reflecting angle of a MEMS reflector of a MEMS scanning touch panel in accordance with the present invention;

FIG. 8 is a schematic view showing a coordinate detection method of MEMS scanning touch point of the present invention;

FIG. 9 is a schematic view of showing an inactive pixel coordinate calculation method performed by an image signal processor of the present invention;

FIG. 10 is a schematic view of a coordinate detection method of a quadrilateral projected on a display screen by a touch point in accordance with the present invention;

FIG. 11 is a schematic view of a detection method of an area projected on a display screen by a touch point in accordance with the present invention;

FIG. 12 is a flow chart of a coordinate detection method of a touch point in accordance with the present invention, and FIG. 12(A) shows a flow chart of a coordinate detection method of a single touch point, and FIG. 12(B) shows a flow chart of a detection method of an area and its coordinates projected on a display screen by a touch point;

FIG. 13 is a schematic view of controlling the timing of a MEMS scanning touch panel in accordance with the present invention;

FIG. 14 is a schematic view of a MEMS scanning touch panel in accordance with a second preferred embodiment of the present invention; and

FIG. 15 is a schematic view of a light source module of a MEMS scanning touch panel in accordance with a second preferred embodiment of the present invention.

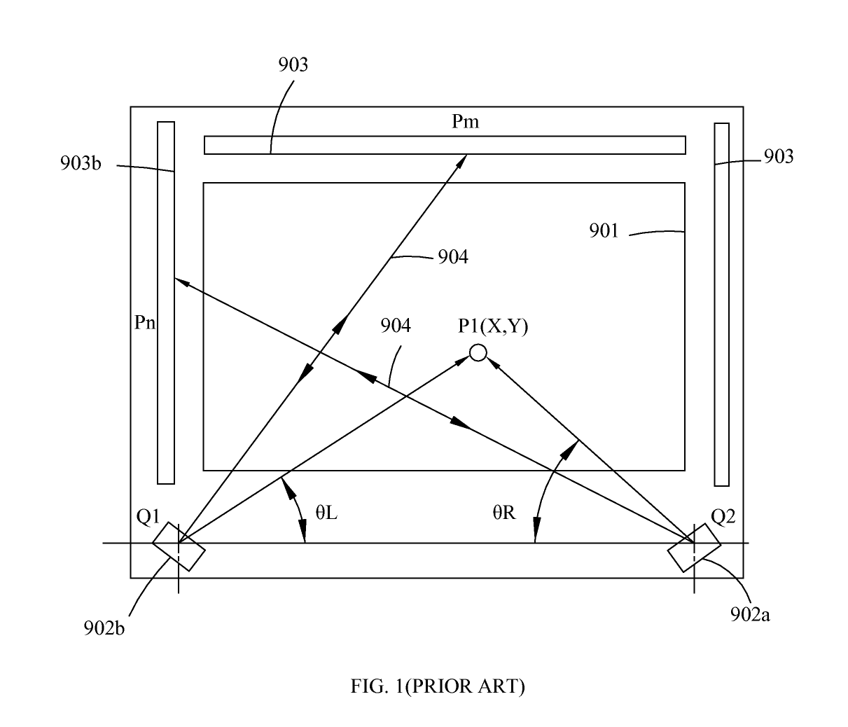

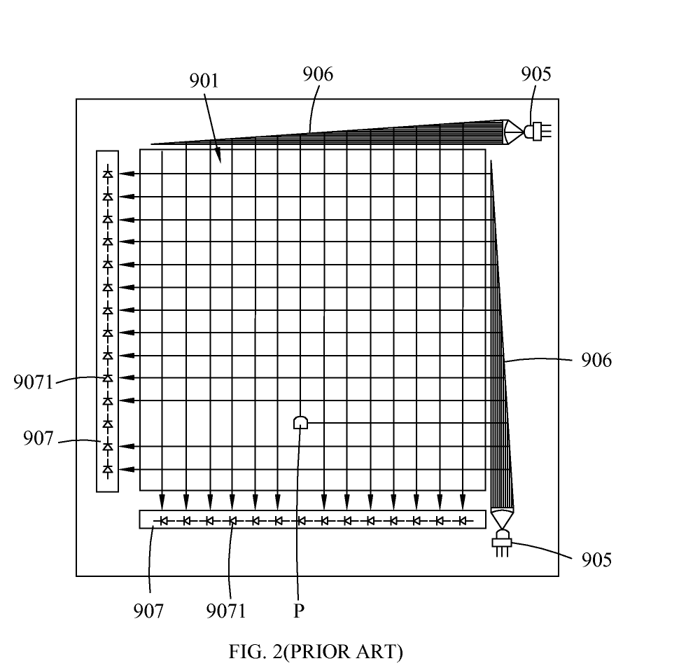

### DETAILED DESCRIPTION OF THE PREFERRED EMBODIMENTS

To make it easier for our examiner to understand the technical characteristics and effects of the present invention, we use preferred embodiments and related drawings for the detailed description of the present invention as follows:

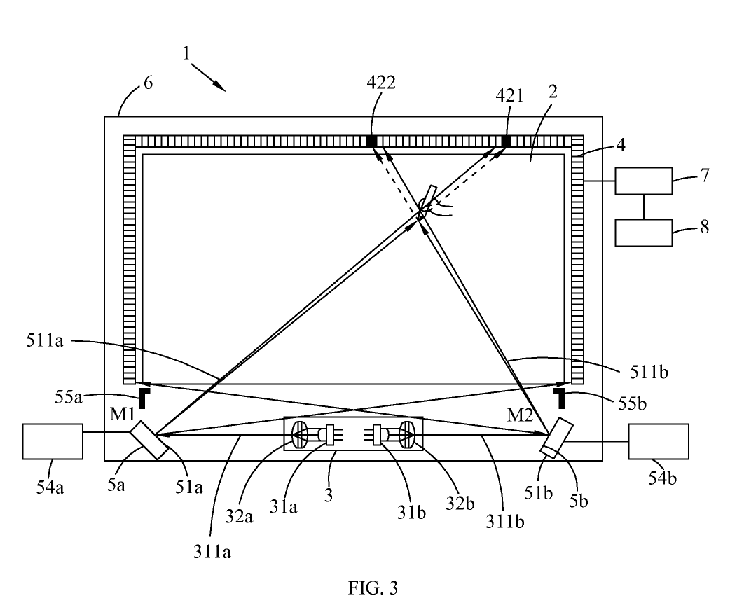

At present, most optical scanning devices use the high-speed rotation of a polygon mirror to control a laser light scanning, but the polygon mirror driven by hydraulic pressure has the disadvantages of a limited rotation speed, high price, loud sound and slow startup. Thus, such polygon mirrors are out of date and no longer meets the requirements of high speed and high precision. In recent years, a micro-electronic-mechanic system oscillatory reflector (MEMS reflector) having a torsion oscillator is introduced or applied to an imaging system, a scanner or a laser printer of a laser scanning unit (LSU), and scanning efficiency thereof is higher than that of a conventional polygon mirror. Please refer to FIG. 5 for a schematic view of a MEMS reflector 5 used in the present invention, the MEMS reflector 5 has a reflecting surface 51 coating with aluminum, silver or any other reflective substance, and a center of reflection 53 of the reflecting surface 51 situated on a resonant shaft 52, such that the MEMS reflector 5 is driven by a MEMS controller 54a or 54b (as shown in FIG. 3), and the MEMS controller 54a or 54b has a circuit board with a bridge circuit and a torsion oscillator. The reflecting surface 51 is driven by a resonant magnetic field to perform a resonant oscillation with respect to the resonant shaft 52, and the circuit board with a bridge circuit can generate a pulse signal with a constant frequency to drive the reflecting surface 51 to oscillate with such frequency, and the torsion oscillator can control the amplitude of the reflecting surface 51, such that the reflecting surface 51 oscillates in a predetermined amplitude range.

If the laser light is projected towards the reflecting surface 51 of the MEMS reflector 5, the reflecting surface 51 will be rotated to an angle varied with time, such that the laser light incident to the reflecting surface 51 of the MEMS reflector 5 will be reflected at different angles with respect to the resonant shaft 52 of the MEMS reflector 5 to scan, and the oscillation angle of the reflecting surface 51 is equal to ±½θₚ. The laser light incident to the reflecting surface 51 will be reflected by the reflecting surface 51, the scanning angle of the laser light is equal to ±θₚ. For example, a 26° MEMS reflector 5 is selected, the reflecting surface 51 oscillates at an angle of ±26°, and the scanning angle of the laser light is equal to ±52°, thus the scanning range is equal to 104°. Since the MEMS reflector 5 has the characteristics of ignoring the influence of optical wavelength and wide scanning angle, the MEMS reflector 5 is used extensively in products as well as science and industrial applications.

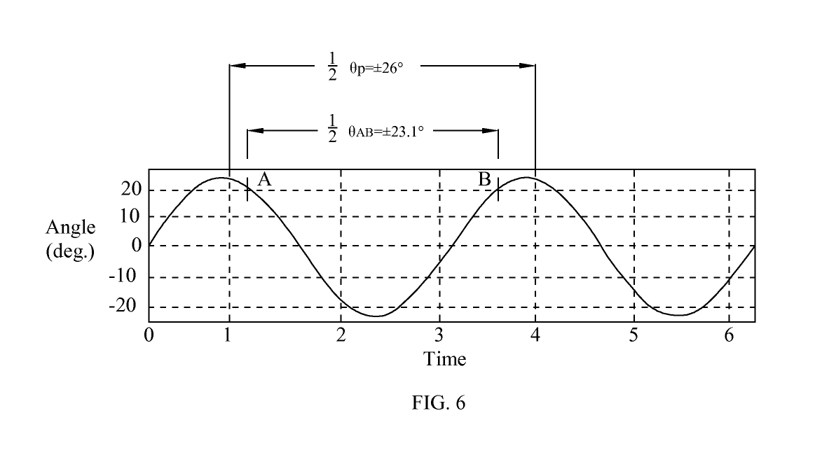

In general, the resonant frequency of the MEMS reflector 5 approximately equals to 2 KHz to 4 KHz. If 2.5 KHz is used as an example of the oscillation frequency of the MEMS reflector 5 for the illustration, as shown in FIG. 6, a period of scanning may be completed in 0.4 sec, and the oscillation angle of the reflecting surface 51 is ±½θₚ=±26° in one period, and the scanning range of the laser light is equal to 104° within one period.

With reference to FIG. 3 for a schematic view of a MEMS scanning touch panel 1 in accordance with a first embodiment of the present invention, a display screen frame 6 contains a display screen 2, a light source modules 3, two MEMS reflectors 5 (5a, 5b), an image sensor 4 and two shades 55a, 55b. The image sensor 4 is electrically coupled to an image signal processor 7 and a coordinate calculator 8.

The light source modules 3 is disposed on the distal edge (i.e. the first edge) and under the distal surface of display screen 2 The light source modules 3 includes two laser light sources 31a, 31b and two collimator lenses 32a, 32h disposed on the same edge of the display screen 2. The laser light sources 31a, 31b may emit laser light, which is generally an infrared light (IR light) emitted from an infrared laser (IR laser). The collimator lenses 32a, 32b may focus the laser light to form a concentrated parallel laser light 311a, 311b to be projected towards the MEMS reflectors 5a, 5b.

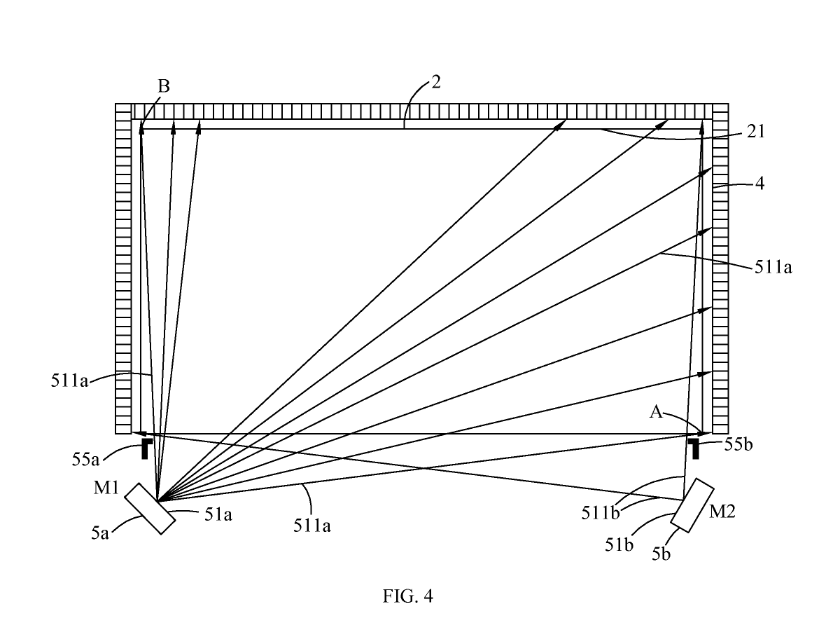

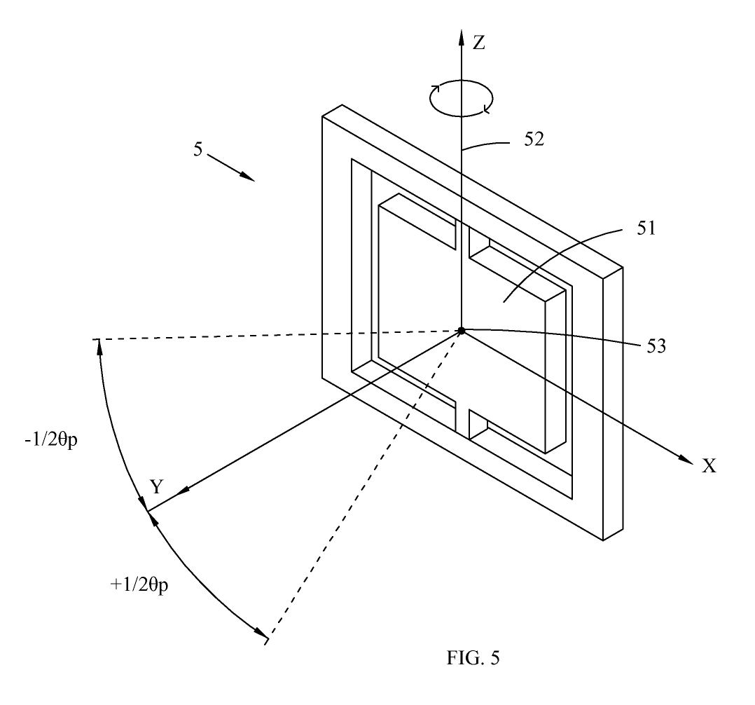

The MEMS reflectors 5a, 5b disposed separately on the same distal edge (the first edge) of the display screen 2. The MEMS reflector 5a or 5b has a reflecting surface 51a or 51b resonantly oscillating with respect to the resonant shaft of the reflecting surface 51. The concentrated parallel laser light 311a or 311b that incident to center of reflection of the MEMS reflector 5a or 5b is reflected to be scanning light beams 511a or 511b to scan across the display screen 2 within an effective range 21 of the screen 2 (as shown in FIG. 4).

The image sensor 4 is disposed on the other three distal edges (i.e. the second, third and fourth edges) of the display screen 2 and corresponding to the first edge of the MEMS reflectors 5a, 5b. The image sensor 4 is used to receive the scanning light beams 511a, 511b and to form linear images including active pixels and inactive pixels 421, 422. The image signal processor 7 captures the linear images formed by the image sensor 4 and transforms active pixels and inactive pixels 421, 422 of the linear images into electronic signals. The coordinate calculator 8 receives the electronic signals generated by the image signal processor 7, and calculates the coordinates of the touch point according to the coordinates of the centers of the reflecting surfaces 51a, 51b of the two MEMS reflectors. The coordinate calculator 8 outputs the coordinates of the touch point for further applications.

The shades 55a, 55b are disposed at positions corresponding to the MEMS reflectors 5a, 5b to block scanning light beams 511a, 511b incident to the invalid scanning area of the display screen 2. The shades 55a, 55b avoid the image sensor 4 to receive the scanning light beams 511a, 511b incident to the invalid scanning area so as to prevent a ghost image.

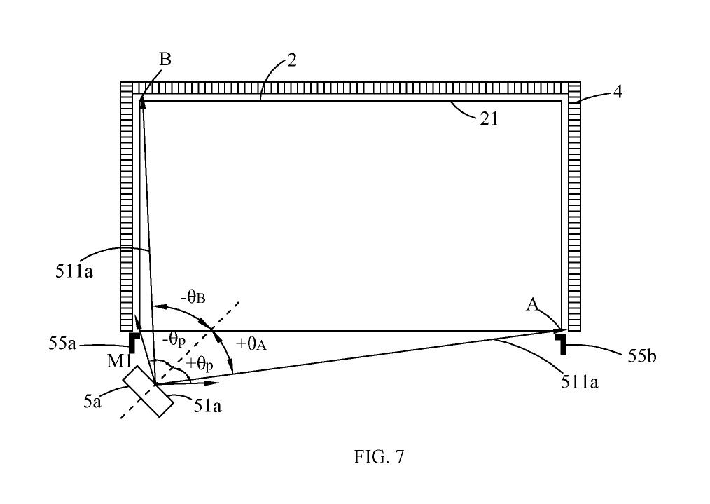

The valid scanning area and invalid scanning area are illustrated in FIGS. 4, 6 and 7. In FIGS. 4 and 7, the shades 55a, 55b are disposed at corners under the first edge of the display screen 2, such that when the reflecting surfaces 51a, 51b of the MEMS reflectors 5a, 5b oscillates ±½θₚ=±26° in a period, the scanning angle is equal to 104°. In FIGS. 6 and 7, to prevent a light from entering into the left-side image sensor 4, the shade 55a can block the scanning light beams 511a exceeding the angle −θ_{B} so that the valid scanning area is defined the range between the angles ±θ_{AB}. In the example, ±θ_{AB}=±46.2, and ±½θ_{AB}=±23.1°. The invalid scanning area is defined the range of the difference angle between −θ_{B} and −θ_{P}.

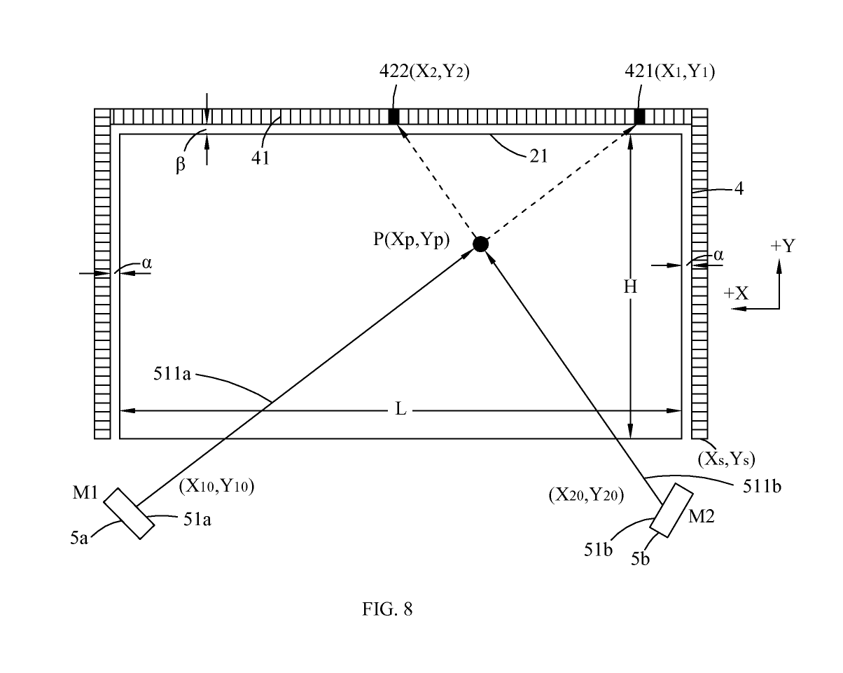

Referring to FIG. 8, if a finger or a pen produces a touch point P on the display screen 2, and the touch point P is appeared to block the scanning light beams 511a, 511b from being incident into the image sensor 4, then the Cartesian coordinates (X_{P},Y_{P}) of the touch point P on plane X-Y may be calculated by Equation (1):

$$\{ \begin{matrix}{X}_{P} = \frac{1}{( {m}_{1 P} - {m}_{2 P} )} ( ( {m}_{1 P} {X}_{10} - {m}_{2 P} {X}_{20} ) - ( {Y}_{10} - {Y}_{20} ) ) \\ {Y}_{P} = \frac{1}{( {m}_{1 P} - {m}_{2 P} )} ( ( {m}_{1 P} {Y}_{20} - {m}_{2 P} {Y}_{10} ) - ( {m}_{1 P} {X}_{20} - {m}_{2 P} {X}_{10} ) )\end{matrix} \\ where \\ {m}_{1 P} = \frac{( {Y}_{10} - {Y}_{1} )}{( {X}_{10} - {X}_{1} )} \\ {m}_{2 P} = \frac{( {Y}_{20} - {Y}_{2} )}{( {X}_{20} - {X}_{2} )} \qquad ( 1 )$$

where, (X₁,Y₁) is coordinate of a first inactive pixel 421 on a linear image 41; (X₂,Y₂) is the coordinate of a second inactive pixel 422 on the linear image 41; (X₁₀,Y₁₀) is the coordinate of a center of reflection 53a of the MEMS reflector 5a; and (X₂₀,Y₂₀) is the coordinate of a center of reflection 53b of the MEMS reflector 5b.

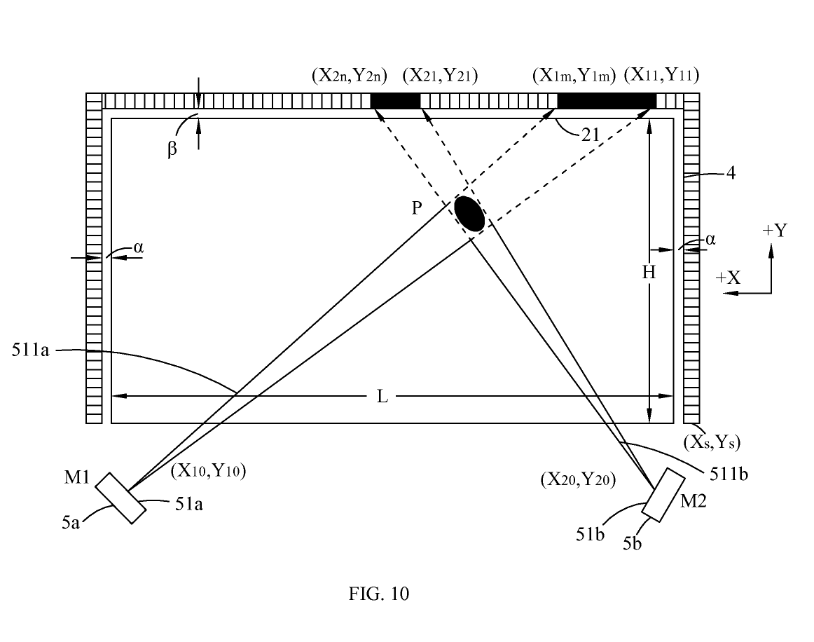

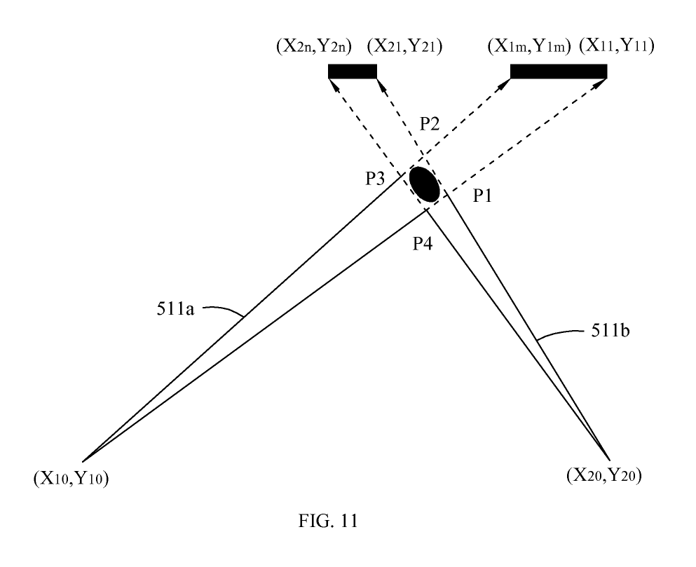

If a finger or a pen produces a touch point P on the display screen 2, and the area of the touch point P is greater than a range of a pixel of an image detected by the image sensor 4 as shown in FIGS. 10 and 11, and a quadrilateral is formed by projecting the touch area P onto the display screen 2 on plane X-Y, and the Cartesian coordinates P1(X_{P1},Y_{P1}), P2(X_{P2},Y_{P2}), P3(X_{P3},Y_{P3}) and P4(X_{P4},Y_{P4}) of the vertices of the quadrilateral may be calculated by Equation (2):

$$\{ \begin{matrix}{X}_{P 1} = \frac{1}{( {m}_{1 P 1} - {m}_{2 P 1} )} ( ( {m}_{1 P 1} {X}_{10} - {m}_{2 P 1} {X}_{20} ) - ( {Y}_{10} - {Y}_{20} ) ) \\ {Y}_{P 1} = \frac{1}{( {m}_{1 P 1} - {m}_{2 P 1} )} ( ( {m}_{1 P 1} {Y}_{20} - {m}_{2 P 1} {Y}_{10} ) - ( {m}_{1 P 1} {X}_{20} - {m}_{2 P 1} {X}_{10} ) )\end{matrix} \\ where \\ {m}_{1 P 1} = \frac{( {Y}_{10} - {Y}_{11} )}{( {X}_{10} - {X}_{11} )} \\ {m}_{2 P 1} = \frac{( {Y}_{20} - {Y}_{21} )}{( {X}_{20} - {X}_{21} )} \\ \{ \begin{matrix}{X}_{P 2} = \frac{1}{( {m}_{1 P 2} - {m}_{2 P 2} )} ( ( {m}_{1 P 2} {X}_{20} - {m}_{2 P 2} {X}_{10} ) - ( {Y}_{20} - {Y}_{10} ) ) \\ {Y}_{P 2} = \frac{1}{( {m}_{1 P 2} - {m}_{2 P 2} )} ( ( {m}_{1 P 2} {Y}_{10} - {m}_{2 P 2} {Y}_{20} ) - ( {m}_{1 P 2} {X}_{10} - {m}_{2 P 2} {X}_{20} ) )\end{matrix} \\ where \\ {m}_{1 P 2} = \frac{( {Y}_{20} - {Y}_{21} )}{( {X}_{20} - {X}_{21} )} \\ {m}_{2 P 2} = \frac{( {Y}_{10} - {Y}_{1 m} )}{( {X}_{10} - {X}_{1 m} )} \\ \{ \begin{matrix}{X}_{P 3} = \frac{1}{( {m}_{1 P 3} - {m}_{2 P 3} )} ( ( {m}_{1 P 3} {X}_{10} - {m}_{2 P 3} {X}_{20} ) - ( {Y}_{10} - {Y}_{20} ) ) \\ {Y}_{P 3} = \frac{1}{( {m}_{1 P 3} - {m}_{2 P 3} )} ( ( {m}_{1 P 3} {Y}_{20} - {m}_{2 P 3} {Y}_{10} ) - ( {m}_{1 P 3} {X}_{20} - {m}_{2 P 3} {X}_{10} ) )\end{matrix} \\ where \\ {m}_{1 P 3} = \frac{( {Y}_{10} - {Y}_{1 m} )}{( {X}_{10} - {X}_{1 m} )} \\ {m}_{2 P 3} = \frac{( {Y}_{20} - {Y}_{2 n} )}{( {X}_{20} - {X}_{2 n} )} \\ \{ \begin{matrix}{X}_{P 4} = \frac{1}{( {m}_{1 P 4} - {m}_{2 P 4} )} ( ( {m}_{1 P 4} {X}_{20} - {m}_{2 P 4} {X}_{10} ) - ( {Y}_{20} - {Y}_{10} ) ) \\ {Y}_{P 4} = \frac{1}{( {m}_{1 P 4} - {m}_{2 P 4} )} ( ( {m}_{1 P 4} {Y}_{10} - {m}_{2 P 4} {Y}_{20} ) - ( {m}_{1 P 4} {X}_{10} - {m}_{2 P 4} {X}_{20} ) )\end{matrix} \\ where \\ {m}_{1 P 4} = \frac{( {Y}_{20} - {Y}_{2 n} )}{( {X}_{20} - {X}_{2 n} )} \\ {m}_{2 P 4} = \frac{( {Y}_{10} - {Y}_{11} )}{( {X}_{10} - {X}_{11} )} \qquad ( 2 )$$

Where, (X₁₁,Y₁₁) is the coordinate of a first inactive pixel 421 on a linear image 41; (X₁ₘ,Y₁ₘ) is the coordinate of the last pixel of the continuous pixels of the first inactive pixel 421 on the linear image 41, (X₂₁,Y₂₁) is the coordinate of a second inactive pixel 422 on the linear image 41; (X₂ₙ,Y₂ₙ) is the coordinate of the last inactive pixel of the continuous inactive pixels of the second inactive pixel 422 on the linear image 41; (X₁₀,Y₁₀) is the coordinate of a center of reflection 53a of the MEMS reflector 5a; and (X₂₀,Y₂₀) is the coordinate of a center of reflection 53b of the MEMS reflector 5b.

The coordinates (X_{Pc},Y_{Pc}) of a geometric center of the quadrilateral produced by the touch area P on the display screen 2 may be calculated by Equation (3):

$$\{ \begin{matrix}{X}_{Pc} = \frac{1}{4} {\sum }_{i = 1}^{4} {X}_{Pi} \\ {Y}_{Pc} = \frac{1}{4} {\sum }_{i = 1}^{4} {Y}_{Pi}\end{matrix} \qquad ( 3 )$$

An area A_{P} of the quadrilateral produced by the touch area P on the display screen 2 may be calculated by Equation (4):

$${A}_{P} = \frac{1}{2} \vert {X}_{P 1} {Y}_{P 2} + {X}_{P 2} {Y}_{P 3} + {X}_{P 3} {Y}_{P 4} + {X}_{P 4} {Y}_{P 1} - ( {X}_{P 1} {Y}_{P 4} + {X}_{P 2} {Y}_{P 1} + {X}_{P 3} {Y}_{P 2} + {X}_{P 4} {Y}_{P 3} ) \vert \qquad ( 4 )$$

The coordinates (X_{Pd},Y_{Pd}) of a homogeneous center of the quadrilateral produced by the touch area P on the display screen 2 may be calculated by Equation (5):

$$\{ \begin{matrix}{X}_{Pd} = \frac{1}{6 {A}_{P}} ( \begin{matrix}( {X}_{P 1} + {X}_{P 2} ) ( {X}_{P 1} {Y}_{P 2} - {X}_{P 2} {Y}_{P 1} ) + \\ ( {X}_{P 2} + {X}_{P 3} ) ( {X}_{P 2} {Y}_{P 3} - {X}_{P 3} {Y}_{P 2} ) + \\ ( {X}_{P 3} + {X}_{P 4} ) ( {X}_{P 3} {Y}_{P 4} - {X}_{P 4} {Y}_{P 3} ) + \\ ( {X}_{P 4} + {X}_{P 3} ) ( {X}_{P 4} {Y}_{P 1} - {X}_{P 1} {Y}_{P 4} )\end{matrix} ) \\ {Y}_{Pd} = \frac{1}{6 {A}_{P}} ( \begin{matrix}( {Y}_{P 1} + {Y}_{P 2} ) ( {X}_{P 1} {Y}_{P 2} - {X}_{P 2} {Y}_{P 1} ) + \\ ( {Y}_{P 2} + {Y}_{P 3} ) ( {X}_{P 2} {Y}_{P 3} - {X}_{P 3} {Y}_{P 2} ) + \\ ( {Y}_{P 3} + {Y}_{P 4} ) ( {X}_{P 3} {Y}_{P 4} - {X}_{P 4} {Y}_{P 3} ) + \\ ( {Y}_{P 4} + {Y}_{P 1} ) ( {X}_{P 4} {Y}_{P 1} - {X}_{P 1} {Y}_{P 4} )\end{matrix} )\end{matrix} \qquad ( 5 )$$

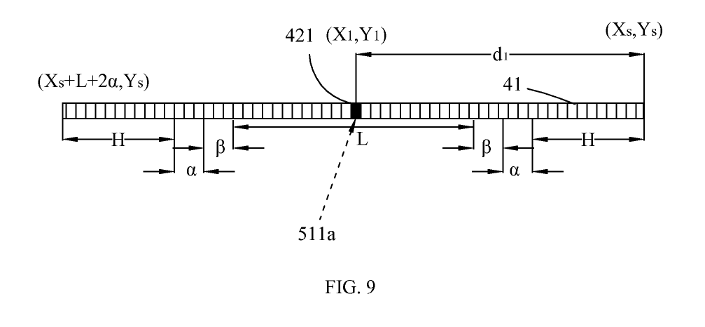

In FIG. 9, the coordinates (X₁,Y₁) of a first inactive pixel 421 on a linear image 41 may be calculated by Equation (6). Similarly, coordinates (X₂,Y₂) or (X₁ₘ,Y₁ₘ), (X₂ₙ,Y₂ₙ) of the second inactive pixels 422 may be calculated:

$$\{ \begin{matrix}if {d}_{1} \leq H + α then \\ {X}_{1} = {X}_{S} \\ {Y}_{1} = {Y}_{S} + {d}_{1} \\ if H + α ≺ {d}_{1} \leq H + L + 2 β + α then \\ {X}_{1} = {X}_{S} + ( d - H - α ) \\ {Y}_{1} = {Y}_{S} + β \\ if H + L + 2 β + α ≺ {d}_{1} \leq L + 2 H + 2 ( α + β ) then \\ {X}_{1} = {X}_{S} + L + α + 2 β \\ {Y}_{1} = {Y}_{S} + 2 ( H + α + β d ) + L - {d}_{1}\end{matrix} \qquad ( 6 )$$

Where, H is the height of the effect range 21 of the screen 2; L is the width of the effective range 21 of the screen 2; α and β are distances between the effective range 21 of the screen 2 and a sensing surface of an image sensor 4 respectively; (Xs, Ys) is the coordinate of an origin of the image sensor 4; and d₁ is the distance from the origin of the image sensor 4 to an inactive pixel 421.

The image sensor 4 may be a serial-scan linear image sensing array or a contact image sensor (CIS) disposed on three distal edges (the second, third and fourth edge) of the display screen 2 and provided for receiving the scanning light beam 511a, 511b and forming the linear image 411 by the scanning light beam 511a, 511b. An active pixel is formed by projecting the scanning light beam 511a, 511b onto the sensing surface of the image sensor 4, and inactive pixels 421, 422 are formed on the sensing surface of the image sensor 4 by blocking the scanning light beam. In general, the serial-scan linear image sensing array has a resolution of 300 DPI˜600 DPI (dot per inch). For example, for a display screen 2 with 20 inches (L-43 cm, H=27 cm), the total length of the scanning light beam 511a (511b) received by the image sensor 4 is equal to 70 cm, which is equivalent to 8,200-16,500 light dots, and thus the present invention may obtain the coordinate of a touch point/touch area with a high resolution. In an alternative embodiment, if the contact image sensor (CIS) has a resolution of 600 DPI˜1200 DPI is used, the resolution is outlined by 16,500˜33,000 light dots. In another embodiment, for a display screen 2 with 52 inches (L=112 cm, H=70 cm), the length of the scanning light beam 511a (511b) received by the image sensor 4 is equal to 182 cm, which is equivalent to 21,500˜43,000 light dots for serial-scan linear image sensing array. Once a contact image sensor (CIS) is used, the resolution is outlined by 43,000˜86,000 light dots. Thus the resolution will not decrease with increasing size of the touch panel (display screen). Hence, the present invention is design suitably for small size touch screen as well as large scale touch screen.

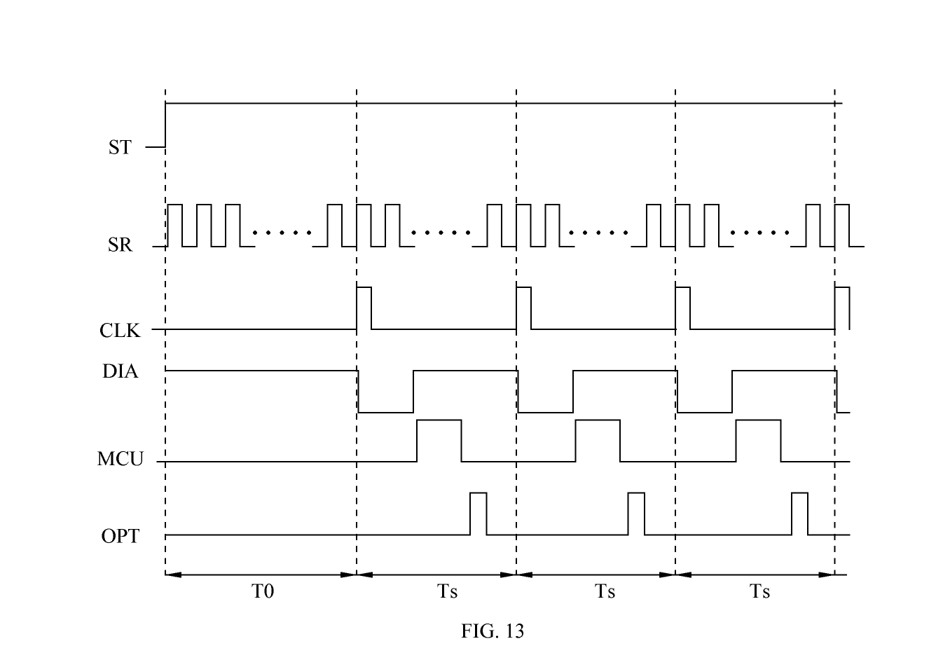

With reference to FIG. 13 for a schematic view of the time sequences of MEMS reflector controllers 54a, 54b, an image sensor 4, an image signal processor 7 and a coordinate calculator 8 of a MEMS scanning touch panel 1 in accordance with the present invention. If a computer system (not shown in the figure) sends out a ST signal (for transmitting from a low level to a high level), the MEMS reflector controllers 54a, 54b will be starting up, and the MEMS reflector controller 54a, 54b will transmit a signal SR to a MEMS reflector 5, and a reflecting surface 51 of the MEMS reflector 5 is triggered and oscillates with a frequency 1, such as oscillating back and forth for one time in 0.4 msec per period. When a clock signal CLK is inputted externally or generated by the image sensor 4, CLK produces a clock (such as Ts= 1/60 sec) at each sample time Ts, such that if the image sensor 4 receives the clock signal CLK, the linear image 41 will be transmitted to the image signal processor 7, and the image signal processor 7 will transform the linear image 41 into a digital signal to be inputted to the coordinate calculator 8. The coordinate calculator 8 calculates the coordinates and area and generates a MCU signal. After the coordinate calculator 8 calculates the coordinates and area the data of the coordinates and area are transmitted to the peripheral device by generating OPT signal. A period is complete.

The image sensor 4 may use a serial-scan linear image sensing array or a contact image sensor, and this embodiment adopts a contact image sensor CIS having a resolution of 600 DPI, and the image signal processor 7 has a memory of 10 Mbyte (but not limited to such arrangement only). In every period Ts(= 1/60 sec), the image sensor 4 transmits an image produced by the scanning light beams 511a, 511b to the memory of the image signal processor 7, and the memory of the image signal processor 7 carries out the data processing and the transmission rate is 133 Mbit (but not limited to such arrangement only). After the image sensor 4 transmits the data to the image signal processor 7, a reset signal (Reset) is enable to clear the image and avoid a saturation situation. For a 20-inch display screen, the contact image sensor CIS transmits 16500 light dot signals in period Ts (with a transmission time approximately equal to 1/1000 sec). For a 52-inch display screen, the contact image sensor CIS transmits 43000 light dot signals in period Ts (with a transmission time approximately equal to 2.5/1000 sec).

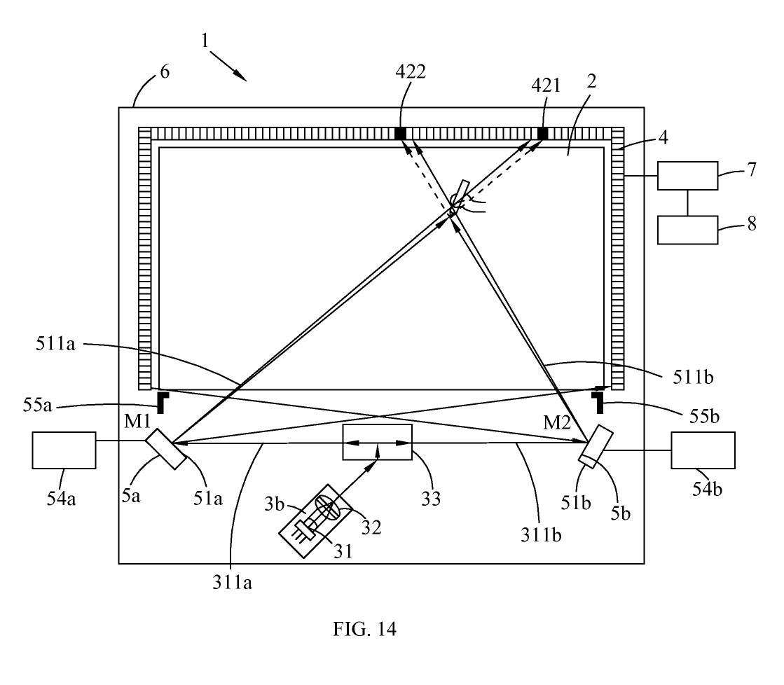

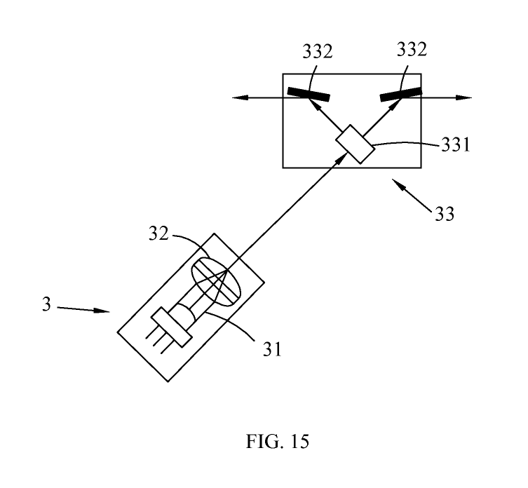

With reference to FIG. 14 for a MEMS scanning touch panel 1 in accordance with a second embodiment of the present invention, a display screen frame 6 contains a display screen 2, a light source module 3, two MEMS reflectors 5 (5a, 5b), an image sensor 4 and two shades 55a, 55b. The image sensor 4 is electrically coupled to an image signal processor 7 and a coordinate calculator 8. The light source module 3 is disposed on a distal edge of the display screen 2 and under the distal edge as shown in FIG. 3, and the light source module 3 comprises a laser light source 31, a collimator lens 32 and a beam splitter 33. The laser light source 31 may emit a laser light which is generally an infrared laser (IR laser) or an infrared laser light (IR light). The collimator lens 32 focuses the laser light to form a concentrated parallel laser light, and the beam splitter 33 splits the laser light into two laser lights 311 (311a, 311b) projected to the centers of the reflecting surfaces 51 of the MEMS reflector 5 (5a, 5b). In FIG. 15, the beam splitter 33 includes a beam splitting element 331 and a reflecting mirror 332. The beam splitting element 331 of this embodiment is formed by a multilayer coating film, and capable of penetrating 50% and reflecting 50% of the incident laser light, but the invention is not limited to such arrangement only. Different penetrative rates and reflective rates, such as 40% penetration and 60% reflection or 60% penetration and 40% reflection, may be used instead. After the laser light source 31 emits the laser light, and the collimator lens 32 focuses the laser light to form a concentrated parallel laser light, the beam splitting element 331 may split the laser light into two laser lights, and the reflecting mirror 332 projects the two laser lights 311(311a, 311b) in opposite angles of 180° into the center of the reflecting surfaces 51 of the MEMS reflectors 5. In this embodiment, the laser lights are emitted in opposite angles of 180°, but the invention is not limited to such arrangement only, and may not arranged according to the central position of the reflecting surface 51 of the MEMS reflector 5. In this embodiment, only one optical module is used for splitting the laser light into two, and also this embodiment is suitable for the use of a small to mid-sized and low-cost touch panel.

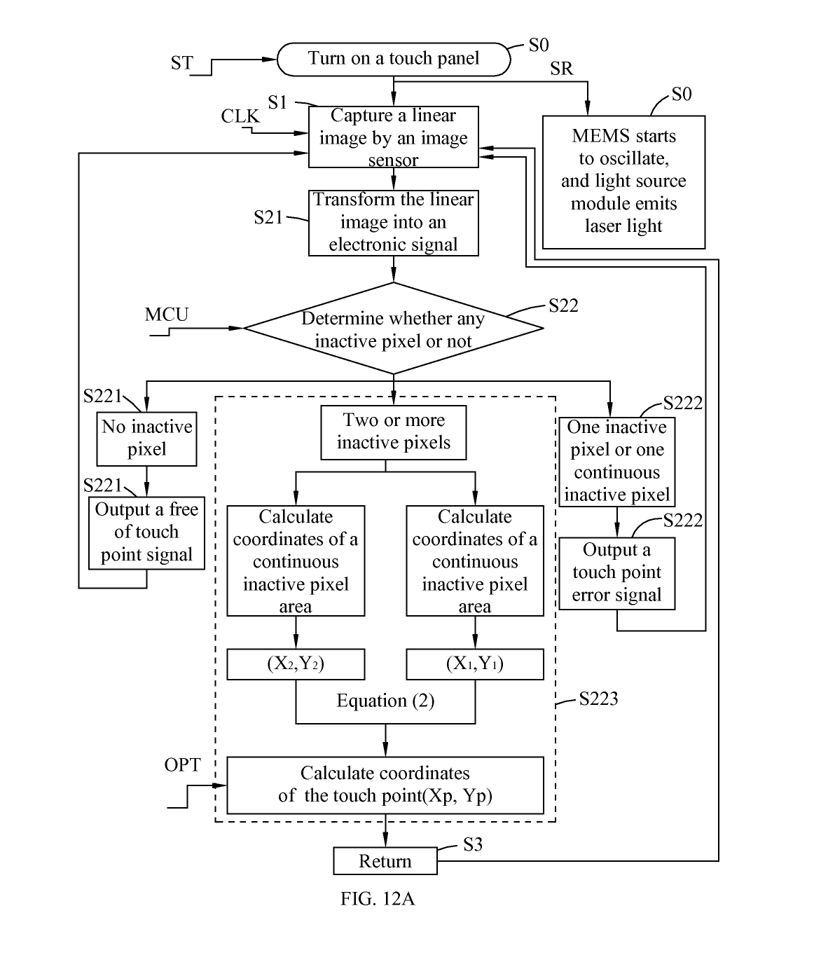

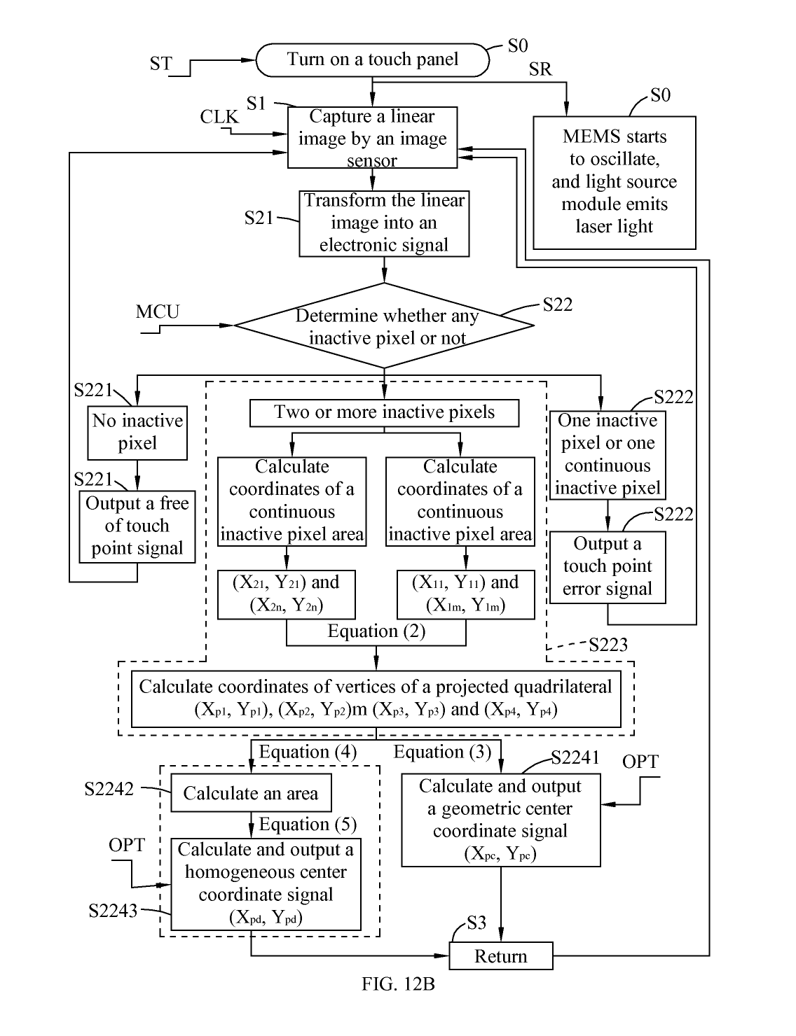

To detect the coordinates of the touch point as illustrated in a flow chart of FIG. 12(A), the present invention provides a coordinate detection method of a MEMS scanning touch panel, and the method comprises the following steps:

Step S0: When a computer system sends out a ST signal for transmitting from a low level to a high level to start detecting coordinates of a touch panel, and the ST signal starts up MEMS controllers 54a, 54b of the MEMS reflector, and a circuit board and a torsion oscillator of the MEMS controller 54a, 54b generate a signal SR with a frequency f and a constant amplitude, starting a resonant oscillation with frequency f and amplitude by the MEMS reflector 5(5a, 5b). Also, starting a light source module 3 (3a, 3b) by the ST signal, such that the light source module 3 emits a laser light.

Step S1: When a computer sends out a ST signal, starting to generate a clock signal CLK for generating a clock signal per a sample time Ts by the image sensor 4, where Ts= 1/60 sec, but not limited thereto. Capturing a linear image 411 (which is indicated by the DIA signal as shown in FIG. 13) by the image sensor 4 whenever each sample time Ts is ended. Therefore, the linear image 411 shows the active pixels that are not blocked by a touch point and the inactive pixel 421 blocked by the touch point.

Step S2: calculating cartesian coordinates (X_{P},Y_{P}) of the touch point P by Equation (1), which including the following steps:
Step S21: transforming the linear image 411 captured by the image sensor 4 into an electronic signal by the image signal processor 7, and transmitting the electronic signal to the coordinate calculator 8.
Step S22: determining whether or not there is an inactive pixel 421 in the electronic signal of the image signal processor 7 by the coordinate calculator 8.
   Step S221: outputting a null signal, if there is no inactive pixel 421.
   Step S222: outputting an error signal if there is only one inactive pixel 421.
   Step S223: calculating coordinate positions (X₁,Y₁) and (X₂,Y₂) of the two inactive pixels 421 by Equation (6)—if there are two discontinuous inactive pixels 421; calculating coordinates (Xp,Yp) (as indicated by the MCU signal in FIG. 13) of the touch point P, and outputting the signal of the coordinates of the touch point P to the peripheral device (as indicated by the OPT signal in FIG. 13).

Step S3: returning to step S1 for next sampling time.

To detect vertex coordinates of a quadrilateral projected on a display screen by a touch area and coordinates of a geometric center of the touch area as shown in the flow chart of FIG. 12(B), the present invention provides a coordinate detection method of a touch area of a MEMS scanning touch panel, and the method comprises the following steps:

Step S0: turning on a MEMS reflector 5(5a, 5b), such that the MEMS reflector 5(5a, 5b) starts a resonant oscillation with predetermined frequency and amplitude, and turning on a light source module 3 (3a, 3b), such that the light source module 3 (3a, 3b) emits a laser light 311 (311a, 311b).

Step S1: capturing a linear image 411 by the image sensor 4 whenever each sample time Ts is ended, wherein the linear image 411 is an image showing active pixels not blocked by a touch area and inactive pixel 421 blocked by the touch area.

Step S2: calculating coordinates P1(X_{P1},Y_{P1}), P2(X_{P2},Y_{P2}), P₃(X_{P3},Y_{P3}) and P4(X_{P4},Y_{P4}) of vertices of a quadrilateral projected on a display screen by a touch area P and coordinates (X_{Pc},Y_{Pc}) of a geometric center projected on a display screen by a touch area P, which including the detailed steps of:

Step S21: transforming the linear image 111 captured by the image sensor 4 into an electronic signal by the image signal processor 7, and transmitting the electronic signal to the coordinate calculator 8.

Step S22: determining whether or not there is an inactive pixel 421 in the electronic signal of the image signal processor 7 by the coordinate calculator 8.

Step S221: outputting a null signal, if there is no inactive pixel 421.

Step S222: outputting an error signal if there is only one continuous inactive pixel 421.

Step S223: calculating coordinate positions (X₁₁,Y₁₁) and (X₁ₘ,Y₁ₘ) of end points at both ends of the first continuous inactive pixel area of the continuous inactive pixel areas by Equation (6), if there are two continuous inactive pixels 421. Calculating the coordinate positions (X₂₁,Y₂₁) and (X₂ₙ,Y₂ₙ) of end points at both ends of the second continuous inactive pixel area of the continuous inactive pixel areas by Equation (6). Calculating coordinates P1(X_{P1},Y_{P1}), P2(X_{P2},Y_{P2}), P3(X_{P3},Y_{P3}) and P4(X_{P4},Y_{P4}) of vertices of a quadrilateral projected on the display screen according to Equation (2). Outputting the signal of the vertex coordinates of a quadrilateral projected on the display screen to the peripheral device.

Step S224: calculating the coordinates of a geometric center projected on the display screen by the touch point, which including the detailed steps of:
Step S2241: calculating coordinates (X_{Pc},Y_{Pc}) of a geometric center of a quadrilateral projected on a display screen by a touch area P according to the coordinates P1(X_{P1},Y_{P1}), P2(X_{P2},Y_{P2}), P3(X_{P3},Y_{P3}) and P4(X_{P4},Y_{P4}) of the vertices of the quadrilateral projected on a display screen according to Equation (3). Outputting the signal of the geometric center of the coordinates (X_{Pc},Y_{Pc}) of the quadrilateral projected on the display screen to the peripheral device.

Step S3: returning to step S1 for next sampling time.

The present invention further provides a method of detecting a homogeneous center by using an area of a quadrilateral projected on a display screen by a touch area of a MEMS scanning touch panel and the coordinates of the touch area projected on the display screen, and the method comprises the following steps:

The method for detecting the area of the quadrilateral projected on the display screen and the coordinates of a homogeneous center thereof is illustrated by a flow chart as shown in FIG. 12(B), and the method comprises the following steps:

Step S0: turning on a MEMS reflector 5 (5a, 5b), such that the MEMS reflector 5(5a, 5b) starts a resonant oscillation with predetermined frequency and amplitude. Turning on a light source module 3 (3a, 3b), such that the light source module 3 (3a, 3b) emits a laser light 311 (311a, 311b).

Step S1: capturing a linear image 411 by the image sensor 4 whenever each sample time Ts is started up, wherein the linear image 411 is an image showing active pixels not blocked by a touch area P and inactive pixel 421 blocked by the touch point.

Step S2: calculating coordinates P1(X_{P1},Y_{P1}), P2(X_{P2},Y_{P2}), P3(X_{P3},Y_{P3}) and P4(X_{P4},Y_{P4}) of vertices of a quadrilateral projected on a display screen by a touch point P.
Step S21: transforming the linear image captured by the image sensor 4 into an electronic signal by the image signal processor 7, and transmitting the electronic signal to the coordinate calculator 8.
Step S22: determining whether or not any inactive pixel 421 is in the electronic signal of the image signal processor 7 by the coordinate calculator 8.
   Step S221: outputting a null signal, if there is no inactive pixel 421.
   Step S222: outputting an error signal if there is only one continuous inactive pixel 421.
   Step S223: calculating coordinate positions (X₁₁,Y₁₁) and (X₁ₘ,Y₁ₘ) of end points on both ends of a first continuous inactive pixel area if there are two continuous inactive pixel areas, calculating coordinate positions (X₂₁,Y₂₁) and (X₂ₙ,Y₂ₙ) of end points on both ends of a second continuous inactive pixel area, calculating coordinates (X_{P1},Y_{P1}), (X_{P2},Y_{P2}), (X_{P3},Y_{P3}) and (X_{P4},Y_{P4}) of vertices of a quadrilateral, and outputting signals of the vertex coordinates of the quadrilateral.
Step S224: calculating an area of the quadrilateral and coordinates of a homogeneous center thereof.
   Step S2242: calculating the area of the quadrilateral A_{P} projected on of the display screen by the touch area P by Equation (4) according to the coordinates (X_{P1},Y_{P1}), (X_{P2},Y_{P2}), (X_{P3},Y_{P3}) and (X_{P4},Y_{P4}) of the vertices of the quadrilateral, and outputting the area signal.
   Step S2243: calculating coordinates of a homogeneous center (X_{Pd},Y_{Pd}) and the area of the quadrilateral A_{P} according to the vertex coordinates of the quadrilateral, and outputting coordinates of a homogeneous center (X_{Pd},Y_{Pd}).

Step S3: returning to step S1 for next sampling time.

In summation of the description above, the MEMS scanning touch panel and touch point/area coordinate detection method of the present invention has the advantages of using the high-speed oscillation of the MEMS to reflect a scanning light to achieve the high-speed scanning to enhance the resolution of the touch panel significantly, while calculating the projection area of the touch point/area projected on the display screen, and thus the method is suitable for touch panels of various different sizes and require a high resolution.

It is noteworthy to point out that the MEMS reflector and MEMS controller of the MEMS scanning touch panel of the present invention may be substituted by a polygon mirror and a polygon mirror controller to achieve an equivalent laser light scanning effect.

What is claimed is:

1. A micro-electro-mechanical system (MEMS) scanning touch panel, comprising:
a display screen comprising a first edge, a second edge, a third edge, and a fourth edge;
a light source module disposed on the first edge of the display screen and emitted laser light;
two MEMS reflectors disposed separately on both ends of the first edge of the display screen and being resonantly oscillated, each of the two MEMS reflectors comprising a reflecting surface, the laser light emitted from the light source module incident to center of the reflecting surface of each of the two MEMS reflectors and reflected to be scanning light beams to scan across the display screen;
an image sensor, disposed at the second, the third, and the fourth edges of the display screen, used for receiving the scanning light beams and forming a linear image;
an image signal processor for capturing the linear image formed by the image sensor and transforming the linear image into a corresponding electronic signal; and
a coordinate calculator for receiving the electronic signal generated by the image signal processor and calculating coordinates thereof;
wherein when a touch point on the display screen is generated, the scanning light beams are blocked and are not incident into the image sensor, the image sensor then forms the corresponding linear image, and the image signal processor transforms the linear image into the corresponding electronic signal, and the coordinate calculator receives the electronic signal and calculates coordinates of the touch point according to the coordinates of the center of the reflecting surfaces of the two MEMS reflectors and the coordinates of the inactive pixels.

2. The MEMS scanning touch panel as set forth in claim 1, wherein the light source module comprising a laser light source for emitting the laser light and a beam splitter for splitting the laser light.

3. The MEMS scanning touch panel as set forth in claim 1, wherein the light source module further comprises a collimator lens for focusing the laser light into a concentrated parallel laser light.

4. The MEMS scanning touch panel as set forth in claim 1, wherein the light source module comprises two laser light sources for emitting the laser light respectively.

5. The MEMS scanning touch panel as set forth in claim 4, wherein the light source module further comprise two collimator lenses, each the collimator is used for focusing the laser light emitted from the laser light source respectively to form a concentrated parallel laser light.

6. The MEMS scanning touch panel as set forth in claim 1, wherein the image sensor is one selected from a collection of a contact image sensor (CIS) and a serial-scan linear image sensing array.

7. The MEMS scanning touch panel as set forth in claim 1, further comprising two shades disposed at a position corresponding to each of the two MEMS reflectors to block the scanning light beams that are incident into an invalid area to the display screen to prevent the image sensor from receiving the scanning light beams of an invalid area and from producing a ghost image.

8. A MEMS scanning coordinate detection method for applying to a MEMS scanning touch panel and detecting a coordinate of touch point, the MEMS scanning touch panel comprising a display screen, two MEMS reflectors, the method comprising the steps of:
triggering the two MEMS reflectors to oscillate at a predetermined resonant frequency and a predetermined resonant amplitude;
emitting laser light to the two MEMS reflectors respectively, and the laser light being reflected to be scanning light beams to scan across the display screen;
capturing the linear images including active pixels that the scanning light beams are not blocked or inactive pixels that the scanning light beams are blocked, at each sample time Ts;
transforming the linear images into corresponding electronic signals;
determining whether or not the electronic signals indicating any inactive pixel;
calculating coordinates of the two inactive pixels when two inactive pixels are existed;
calculating the coordinate of the touch point according to the coordinates of the center of the reflecting surfaces of the two MEMS reflectors and the coordinates of the two inactive pixels; and
outputting the coordinate of the touch point.

9. A MEMS scanning coordinate detection method for applying to a MEMS scanning touch panel and detecting vertex coordinates of a quadrilateral in accordance with a touch area, the MEMS scanning touch panel comprising a display screen, MEMS reflectors; the method comprising the following steps of:
triggering the two MEMS reflectors to oscillate at a predetermined resonant frequency and a predetermined resonant amplitude;
emitting the laser light to the two MEMS reflectors respectively, and the laser light being reflected to be scanning light beams to scan across the display screen;
capturing the linear images including active pixels that the scanning light beams are not blocked or inactive pixels that the scanning light beams are blocked, at each sample time Ts;
transforming the linear images into corresponding electronic signals;
determining whether or not the electronic signals indicating any continuous inactive pixel area;
calculating coordinates of both end points of each the two continuous inactive pixel areas respectively when two continuous inactive pixel areas are existed;
calculating the vertex coordinates of the touch area according to the coordinates of the center of the reflecting surfaces of the two MEMS reflectors and the coordinates of the both end points of the two continuous inactive pixel areas; and
outputting the coordinates of the touch area.

10. The MEMS scanning coordinate detection method as set forth in claim 9, further comprising the steps of: calculating coordinate of a geometric center of the quadrilateral on the display screen according to the vertex coordinates of the quadrilateral and outputting a signal of the coordinates of the geometric center.

11. The MEMS scanning coordinate detection method as set forth in claim 9, further comprising the steps of: calculating an area of the quadrilateral on the display screen according to the vertex coordinates of the quadrilateral and outputting a signal thereof.

12. The MEMS scanning coordinate detection method as set forth in claim 11 further comprising the step of calculating a coordinate of homogeneous center of the quadrilateral on the display screen and outputting a signal of the coordinates of the homogeneous center.
